(19) United States
(12) Patent Application Publication
(10) Pub. No.: US 2025/0304802 A1
(43) Pub. Date: Oct. 2, 2025

(54) METHOD AND COMPONENT FOR METALLIC FINISH TREATMENT

(71) Applicant: LACKS ENTERPRISES, INC., Grand Rapids, MI (US)

(72) Inventors: Matthew GRAHAM, Portland, MI (US); David WALTERS, Grand Rapids, MI (US)

(73) Assignee: LACKS ENTERPRISES, INC., Grand Rapids, MI (US)

(21) Appl. No.: 19/091,194

(22) Filed: Mar. 26, 2025

Related U.S. Application Data
(60) Provisional application No. 63/570,146, filed on Mar. 26, 2024.

(51) Int. Cl. C09D 7/41; C09D 187/00

(52) U.S. Cl. CPC C09D 7/41; C09D 187/00

(57) ABSTRACT

A trim component for an interior or exterior body of the vehicle includes a substrate formed of a translucent synthetic resin such as polycarbonate, acrylic, polystyrene, polypropylene, ABS/MABS, polypropylene, TPU, PSU, polyamide, polyesters, styrenics, ASA, polysilicone, PETG, PCABS, and/or other resins or combinations of resins, and a paint layer formed on a surface of the substrate. The paint layer formed of the chrome-like high-metallic organic binder is applied over the surface of the substrate. Further, the paint layer is also a clear and translucent finish such that light emitted from a light source is able to pass through the paint layer. The trim component also includes a coating layer formed on the surface of the paint layer.

### CROSS-REFERENCE TO RELATED APPLICATIONS

This application claims priority to and the benefit of U.S. Provisional Patent Application No. 63/570,146, filed on Mar. 26, 2024, which is incorporated herein by reference in its entirety.

### FIELD

The present disclosure relates to a trim component for vehicles. More particularly, the present disclosure relates to a trim component with a metal-like finish formed on an interior or exterior body of the vehicles.

### BACKGROUND

The statements in this section merely provide background information related to the present disclosure and may not constitute prior art.

In order to lighten an interior part and an exterior part of a vehicle, a part formed with a resin such as an ABS resin or polyamide resin is generally used. In addition, in order to impart luxurious feel and aesthetic to the part, a plating coat having a metallic gloss such as chromium or tinted chromium is formed on the surface of the part formed with the resin. Traditional chrome plating creates a smooth, bright chrome finish. Further, it has been desired to have tinted lustrous metallic finishes, such as black chrome gold-tinted chrome, and other tinted or colored metallic finishes for decorative purposes. More specifically, there has been a desire for clear polymeric decorative coatings that allow the brightness and luster of chrome plating to be seen, while modifying the appearance by imparting a color or tint to the chrome plating.

Several methods have been used in an attempt to achieve colored metallic finishes. One method involves electroplating process, in which black chrome and bronze finishes can be created. A problem with the electroplating process, however, is that it is difficult to consistently obtain a desired colored metallic finish. Further, the electroplating process is limited to black and bronze colors or combination thereof. Another method involves physical vapor depositing (PVD) process. This method offers a wider variety of colors than the electroplating process. The PVD process, however, is very expensive, and thus, its use for achieving a desired colored finish is extremely limited, and also it is difficult to control the gloss of the finishes. Such conventional plating methods cannot provide the imparted high-class image with a low-cost process such that improvements to the plating process are desired to reduce or eliminate those limitations.

### SUMMARY

The present disclosure provides a method and component for a paint layer formed of a chrome-like high-metallic binder applied over the surface of a substrate formed of a synthetic resin. According to an exemplary form of the present disclosure, a trim component for an interior or exterior body of a vehicle includes a substrate formed a synthetic resin and the paint layer applied over the surface of the substrate. Further, the paint layer is formed of a chrome-like high-metallic organic binder.

The paint layer is clear or pigmented and translucent to permit light transmission and give the appearance of a metal surface. The chrome-like high-metallic organic binder provides a visually appealing and distinctive appearance, enhancing the aesthetic appeal of the trim component. Pigments may include but are not limited to aluminum, copper, zinc (or alloys thereof), stainless steel, nickel, or interference pigments (based on mica, or thin metal in-between various plastic, etc.). The pigments may be of any shape but are often non-spherical in nature and may be in the form of platelets, leaves, or flakes. PVD aluminum flakes in particular are preferred for this application because of their high aspect ratio (diameter to thickness), can typically be formulated at high pigment to binder ratios, and which generate a surface that has high specular reflectance.

According to a further aspect of the present disclosure, the substrate is formed of the translucent synthetic resin. In one aspect, the translucent synthetic resin is made of a material comprising at least one of polycarbonate, acrylic, polystyrene, polypropylene, ABS/MABS, polypropylene, TPU, PSU, polyamide, polyesters, styrenics, ASA, polysilicone, PETG, or PCABS. In one aspect, the substrate includes a textured surface such that the surface of the substrate is rough or uneven.

According to a further aspect of the present disclosure, the paint layer formed of the chrome-like high-metallic organic binder is translucent. Accordingly, light emitted from a light source passes through the paint layer.

According to a further aspect of the present disclosure, the trim component further includes a coating layer formed on the surface of the paint layer. The coating layer has a clear coat that is tinted or matted. In addition, the coating layer includes a compound such as silica, alumina, talc, stearates, low molecular weight thermoplastics, and waxes as matting agents.

According to a further aspect of the present disclosure, the trim component further includes an opaque coating layer formed on the surface of the paint layer to achieve areas of selective illumination.

According to another aspect of the present disclosure, the method for forming a trim component used for an interior or exterior body of the vehicle includes the steps of providing a substrate formed of a resin and applying a paint layer over the surface of the substrate. The paint layer is formed of a chrome-like high-metallic organic binder.

According to a further aspect of the present disclosure, the method further includes the step of applying a coating agent to the surface of the paint layer such that a coating layer is formed on the surface of the paint layer.

Further details and benefits will become apparent from the following detailed description of the appended drawings. The drawings are provided herewith purely for illustrative purposes and are not intended to limit the scope of the present disclosure.

### BRIEF DESCRIPTION OF THE DRAWINGS

In order that the disclosure may be well understood, there will now be described various forms thereof, given by way of example, reference being made to the accompanying drawings, in which:

FIG. 1 is a cross-sectional view of a trim component with a chrome-like high-metallic finish layer in accordance with an exemplary form of the present disclosure;

FIG. 2 is a cross-sectional view of the trim component including a coating layer added on the surface of the paint layer of FIG. 1;

FIG. 3 is a cross-sectional view of the trim component with an opaque coating layer added on the surface of the paint layer of FIG. 1;

FIG. 4A is a plan view of the trim component of FIG. 1 when the light is unlit, and FIG. 4B is a plan view of the trim component of FIG. 1 when the light is lit;

FIG. 5A is a plan view of a plated member made by a conventional process when the light is unlit, and FIG. 5B is a plan view of the plated member of FIG. 5A when the light is lit; and

FIG. 6A is a plan view of the trim component of FIG. 1 when the light is unlit, and FIG. 6B is a plan view of the trim component of FIG. 1 when the light is lit.

The drawings described herein are for illustration purposes only and are not intended to limit the scope of the present disclosure in any way.

### DETAILED DESCRIPTION

The following description is merely exemplary in nature and is in no way intended to limit the present disclosure or its application or uses. It should be understood that throughout the drawings, corresponding reference numerals indicate like or corresponding parts and features.

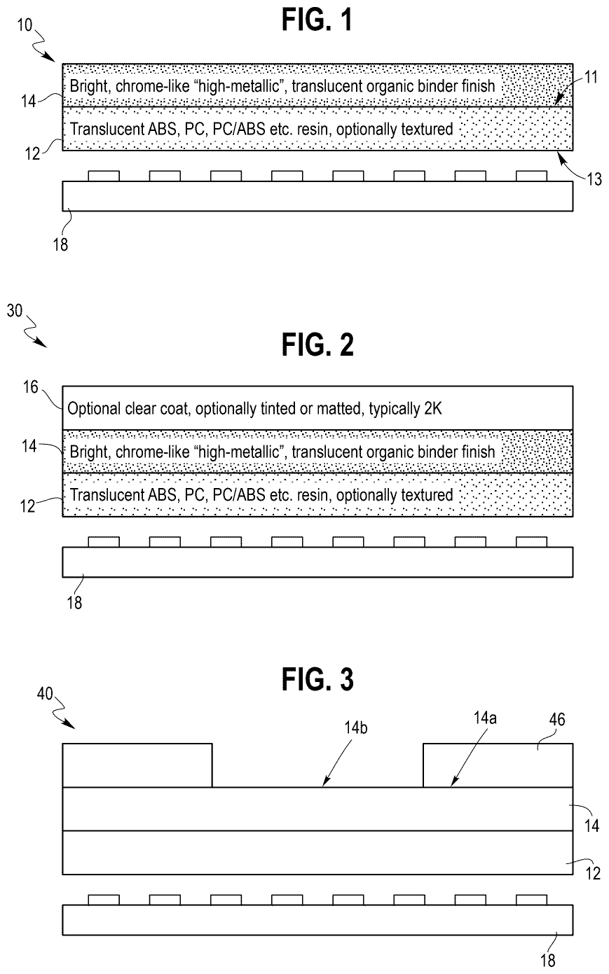

FIG. 1 shows a trim component 10 used in an interior or exterior body of a vehicle. In accordance with an exemplary embodiment of the present disclosure, the trim component 10 may be formed on an interior surface of the vehicle such as a door lever housing, a speaker trim, etc. (not shown), and also formed on an exterior surface of the door such as a door spear, a pillar cover, etc. (not shown). However, the placement of the trim component 10 may be not limited to the areas described above, and may include other areas of the vehicle.

As shown in FIG. 1, the trim component 10 includes a substrate 12 having an A-side surface 11 and a B-side surface 13, and a paint layer 14. The substrate 12 of the trim component 10 is made of a synthetic resin, which may be clear or translucent and may be UV stable. For example, possible synthetic resin materials may include, but are not limited to, polycarbonate, acrylic, polystyrene, polypropylene, TPU, PSU, Polyamide, Polyesters, Styrenics, ASA, polysilicone, PETG, ABS/MABS, or PCABS, such as LER-555, which is a translucent PCABS manufactured by Covestro. The substrate may also be defined or described as a thermoplastic resin molded article. It will be appreciated that this list of possible resins is not exhaustive, and that other molded thermoplastic resin materials or blends of resins not explicitly listed here may also be used for the substrate 12.

The paint layer 14 of the trim component 10 is applied over the surfaces (A-side surface 11 and/or B-side surface 13) of the substrate 12 and is formed of a chrome-like high-metallic organic binder. The paint layer is clear or pigmented and translucent to permit light transmission and give the appearance of a metal surface. The chrome-like high-metallic organic binder provides a visually appealing and distinctive appearance, enhancing the aesthetic appeal of the trim component. Pigments may include but are not limited to aluminum, copper, zinc (or alloys thereof), stainless steel, nickel, or interference pigments (based on mica, or thin metal in-between various plastic, etc.). The pigments may be of any shape but are often non-spherical in nature and may be in the form of platelets, leaves, or flakes. PVD aluminum flakes in particular are preferred for this application because of their high aspect ratio (diameter to thickness), can typically be formulated at high pigment to binder ratios, and which generate a surface that has high specular reflectance.

Further, the paint layer 14 of the trim component 10 may be applied using geometry such as texture to change the visual on the A-side surface 11 and/or B-side surface 13 of the substrate 12. In some embodiments, the paint layer 14 includes one or more layers with multiple paint colors such as a dark color over a light color. Laser etching may also be applied to the paint layer or layers 14 to create a texture or specific appearance. Further, mask painting may be applied on either the A-side surface 11 or B-side surface 13 of the substrate 12. In particular, the paint layer 14 is applied over the surface of the substrate 12 without the use of the conductive (opaque) primer, e.g., via rotary atomizers, solvent selection, etc. with acceptable transfer efficiency. Further, the paint layer 14 formed of the chrome-like high-metallic organic binder is translucent such that light is able to pass through the paint layer 14 like the translucent substrate 12. The paint layer 14 also allows for proper orientation of effect pigment and further promotes certain effect pigments.

As described above, the paint layer or layers 14 may be combined with a textured surface or a texture may be applied with laser etching to the substrate 12. The substrate 12 may be clear or translucent. While an advantage of the present disclosure is the ability for light to pass through the substrate 12 and also the paint layer 14, it will be appreciated that the chrome-like paint layer could also be applied to an opaque substrate. The substrate 12 may be rigid and self-supporting, meaning that the substrate itself may form the shape of the trim component. Put another way, the substrate 12 is not a film that is applied to some other rigid backing structure. The paint layer or layers 14, and any potential texture or laser etching, are not in the form of flexible films applied to the substrate 12.

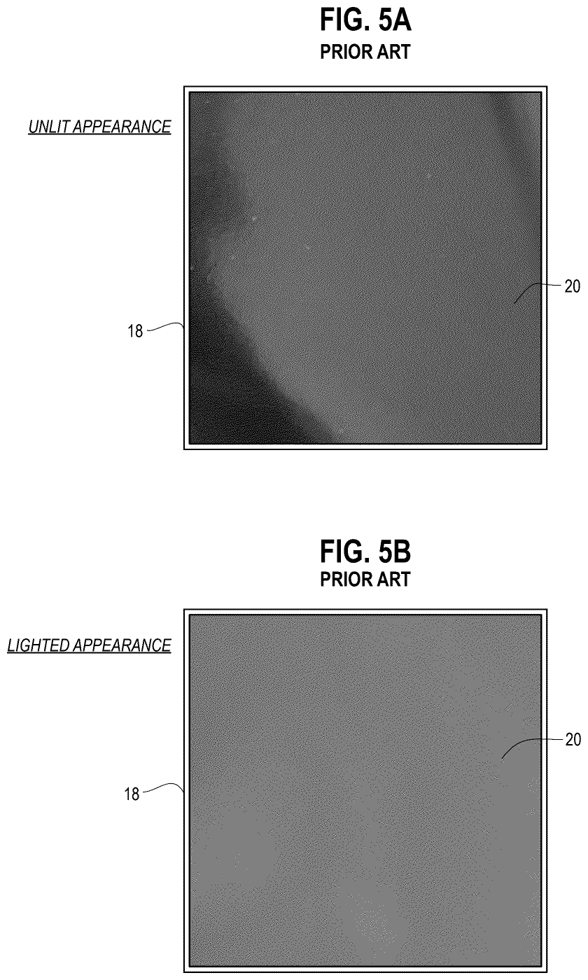

Unlike a conventional process (e.g., an electroplating or other metal deposition procedure) to perform the chrome plating (see an example of the chrome foil finish in FIGS. 5A-5B), it is particularly advantageous to use the chrome-like high-metallic organic binder finish painted on the surface of the substrate 12 because it allows for a nearly infinite number of shape giving designers wide flexibility in determining what will be aesthetically pleasing to the consumer (i.e., no limitations in geometry, contours, etc.) of the trim component 10 having the paint layer 14. It is further advantageous to use the painting process for applying the chrome-like high-metallic organic binder over the surface of the substrate 12 because the poor adhesion or performance such as poor formability, leading to cracking, etc. occurred in the conventional process to perform the chrome plating can be avoided. Accordingly, the paint layer 14 made of the chrome-like high-metallic organic binder and also applied over the surfaces (A-side and/or B-side) of the substrate 12 can be improved for the formability of the trim component 10.

In FIG. 1, further, a light source 18 may be disposed adjacent to the trim component 10 having the substrate 12 and the paint layer 14, which both are the clear and translucent layers. Accordingly, light emitted from the light source 18 may pass through the translucent substrate 12 and the paint layer 14 formed of the translucent organic binder, and be visible through the substrate 12 and the paint layer 14. As shown in FIG. 1, the paint layer 14 formed of the chrome-like high-metallic translucent organic binder is added on the surface of the substrate 12 formed of the synthetic resin. In particular, the chrome-like high-metallic translucent organic binder is applied over the surface of the substrate 12 by a roller or brush such that the paint layer 14 is formed on the surface of the substrate 12. In addition, the light source 18 is formed from an LED, an incandescent, a halogen, a fluorescent, etc., but in the present disclosure, the light source 18 may be not limited to the specific sources listed above. The light source 18 may be connected to a lighting switch (e.g., an actuation mechanism) via a wire, and also be lit or unlit by the actuation mechanism in the vehicle (not shown).

FIG. 2 shows another trim component 30 optionally having a coating layer 16. As shown in FIG. 2, the trim component 30 includes the coating layer 16 in addition to the substrate 12 and the paint layer 14 shown in FIG. 1. The coating layer 16 is coated on the surface of the paint layer 14 for having a clear coat that may be tinted, matted, etc. As shown in FIG. 2, the coating composition of the coating layer 16 may be a clear coating composition, a tinted coating composition, etc. In the present disclosure, for example, because the coating layer 16 having the translucent coating composition is applied to the surface of the paint layer 14 formed of the chrome-like high-metallic organic binder, the entire or at least a portion of the paint layer 14 may be seen through the coating layer 16. For example, the coating composition includes silica, alumina, talc, stearates, low molecular weight thermoplastics, and waxes as an agent.

Further, the tinted or matted coating compositions applied on the surface of the paint layer 14 may be used for allowing the chrome-like high-metallic organic binder finish to be seen through the coating layer 16, while imparting a color or tint to the chrome-like high-metallic organic binder finish of the paint layer 14. In addition, the coating compositions and process of the present disclosure may be used for providing functional coatings, such as protective scratch-resistant coatings, to the painted chrome-like high-metallic organic binder finish. Further, the coating composition may be applied as a liquid or a powder by using electrophoretic deposition techniques.

As shown in FIG. 2, the light source 18 may be also disposed adjacent to the trim component 30 having three layers such as the substrate 12 formed of the translucent synthetic resin, the paint layer 14 formed of the chrome-like high-metallic translucent organic binder, and the coating layer 16 formed of the clear coating composition such that light emitted from the light source 18 passes through all of the layers and also may be visible through the three layers. Accordingly, when the trim components 10 and 30 are each applied to the interior or exterior body of the vehicle and light of the light source 18 is unlit, the light source 18 may be hid by the trim components 10 and 30, but when lit, the trim components 10 and 30 allow for different lighting colors and effects (e.g., texture and/or color tone) of the appearance in the vehicle.

In accordance with another embodiment of the present disclosure, FIG. 3 shows a trim component 40 having a blackout or opaque coating layer 46 on either side of the substrate 12 in order to achieve areas of selective illumination. As shown in FIG. 3, the trim component 40 includes the substrate 12 and the paint layer 14, which are the same as in the embodiment of FIGS. 1 and 2. Further, the trim component 40 includes an opaque coating layer 46 applied on some areas of the metallic paint layer 14 such that a portion 14a of the metallic paint layer 14 is selectively covered by the opaque coating layer (i.e., not exposed) and other portions 14b of the metallic paint layer 14 are not covered by the opaque coating layer 46, which is defined as an exposed portion 14b of the metallic paint layer 14. Further, when the light source 18 may be disposed adjacent to the trim component 40 having three layers such as the substrate 12, the paint layer 14, and the opaque coating layer 46, light emitted from the light source 18 may pass through the substrate 12 and the paint layer 14, and be visible through the exposed portion 14b of the metallic paint layer 14.

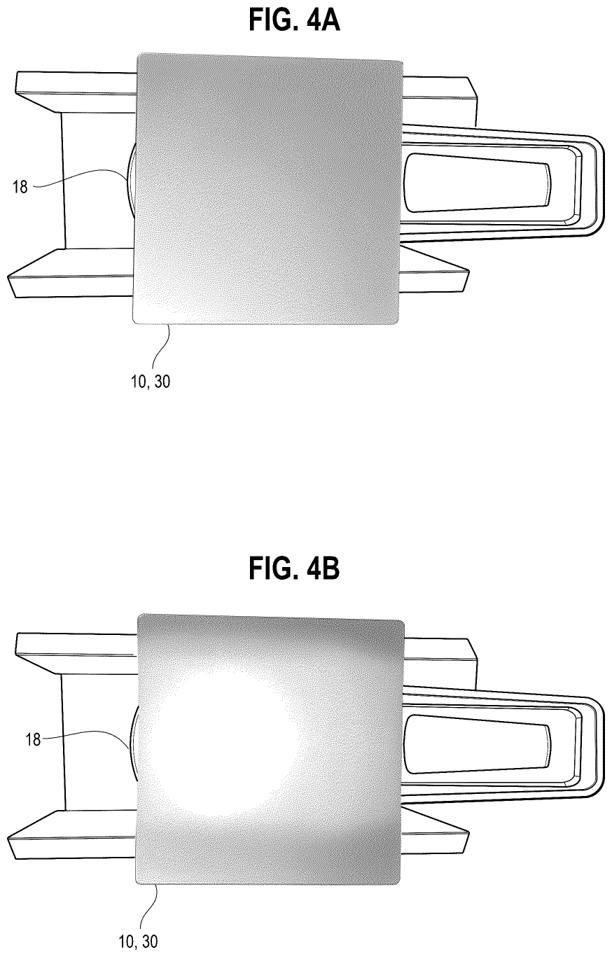

FIGS. 4A and 4B show test examples of the trim component 10, which are disposed adjacent to the light source 18. FIG. 4A shows the color of the trim component 10 disposed to cover the light source 18 when the light is unlit, and FIG. 4B shows the lighting color or effect of the trim component 10 disposed to cover the light source 18 when the light is lit. As shown in FIGS. 4A and 4B, the trim component 10 disposed adjacent to the light source 18 is adapted to allow for various gloss levels, textures, tints, etc. of the paint layer 14 applied over the surface of the substrate 12 when the light is lit or unlit.

FIGS. 5A-5B show a plated member 20 made by the conventional process (e.g., an electroplating or other metal deposition procedure) to perform the chrome plating (i.e., a satin chrome foil finish) to measure the transmissibility of the light source 18. In FIGS. 5A and 5B, as a prior art, the thickness of the substrate formed of a resin material is around 2.7 mm and the thickness of a plating layer formed of a chrome foil is around 0.3 mm. So, the total thickness of the plated member 20 is around 3.0 mm. FIG. 5A shows the plated member's appearance (i.e., texture and/or color) when the plated member 20 is adjacent to the light source 18 and the light is unlit, and FIG. 5B shows the plated member's appearance (i.e., texture and/or color) when the plated member 20 is adjacent to the light source 18 and the light is lit.

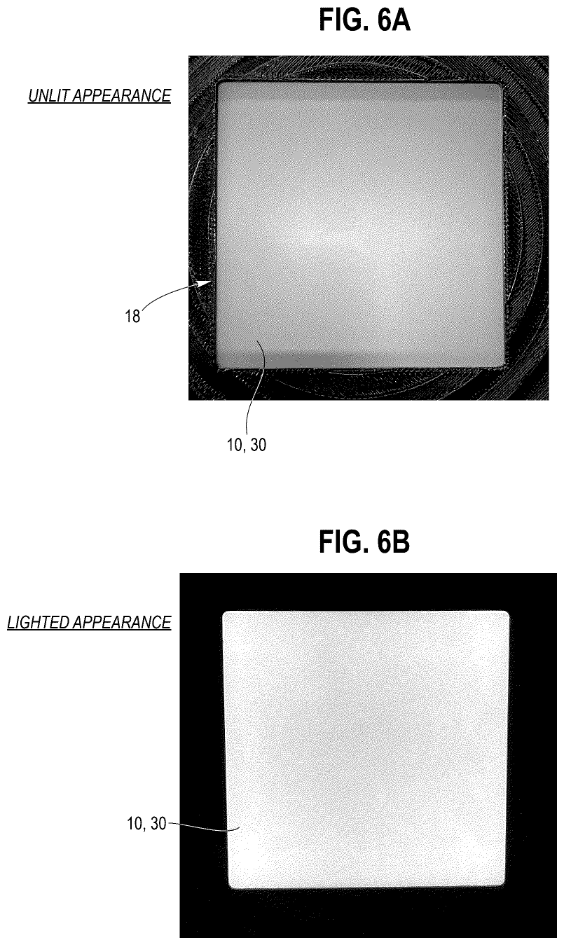

FIGS. 6A-6B show one of the trim components 10 and 30 above formed with the substrate 12 and the paint layer 14 formed of the chrome-like high-metallic organic binder applied over the surface of the substrate 12 to measure the transmissibility of the light source 18. In FIGS. 6A and 6B, for example, the total thickness of the trim component 10 is around 3.5 mm, which is the same thickness as the substrate 10 formed of the synthetic resin because the paint layer 14 formed of the organic binder is very thin. FIG. 6A shows the trim component's 10 appearance (i.e., texture and/or color) when the trim component 10 is adjacent to the light source 18 and the light is unlit, and FIG. 6B shows the trim component's 10 appearance (i.e., texture and color) when the trim component 10 is adjacent to the light source 18 and the light is lit. When compared, accordingly, the trim component 10 formed by the painting process with the chrome-like high-metallic organic binder has approximately 3% better light transmissivity and approximately 280K less color shift (to the warm) than the plated member made by the conventional process to perform the plating layer with the chrome finish foil.

The foregoing description of various forms of the invention has been presented for purposes of illustration and description. It is not intended to be exhaustive or to limit the invention to the precise forms disclosed. Numerous modifications or variations are possible in light of the above teachings. The forms discussed were chosen and described to provide the best illustration of the principles of the invention and its practical application to thereby enable one of ordinary skill in the art to utilize the invention in various forms and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A method for forming a trim component used for an interior or exterior body of the vehicle, the method comprising the steps of:
providing a substrate formed of a resin; and
applying a paint layer over a surface of the substrate,
wherein the paint layer is formed of a chrome-like high-metallic organic binder.

2. The method of claim 1, wherein the substrate is formed of a translucent synthetic resin.

3. The method of claim 1, wherein the chrome-like high-metallic organic binder is translucent such that light emitted from a light source passes through the paint layer.

4. The method of claim 1, further comprising the step of applying a coating agent to a surface of the paint layer such that a coating layer is formed on the surface of the paint layer.

5. The method of claim 4, wherein the coating layer includes a clear coat that is tinted or matted.

6. The method of claim 4, wherein the coating layer includes a compound such as silica, alumina, talc, stearates, low molecular weight thermoplastics, or waxes.

7. The method of claim 1, further comprising the step of applying an opaque coating layer on a surface of the paint layer to achieve areas of selective illumination.

8. The method of claim 2, wherein the translucent synthetic resin is made of a material comprising at least one of polycarbonate, acrylic, polystyrene, polypropylene, ABS/MABS, polypropylene, TPU, PSU, polyamide, polyesters, styrenics, ASA, polysilicone, PETG, or PCABS.

9. A trim component for an interior or exterior body of the vehicle, the trim component comprising:
a substrate formed of a resin; and
a paint layer applied over a surface of the substrate,
wherein the paint layer is formed of a chrome-like high-metallic organic binder.

10. The trim component of claim 9, wherein the substrate is formed of a translucent synthetic resin.

11. The trim component of claim 9, wherein the substrate includes a textured surface such that the surface of the substrate is rough or uneven.

12. The trim component of claim 9, wherein the chrome-like high-metallic organic binder is translucent such that light emitted from a light source passes through the paint layer.

13. The trim component of claim 9, further comprising a coating layer formed on a surface of the paint layer.

14. The trim component of claim 13, wherein the coating layer includes a clear coat that is tinted or matted.

15. The trim component of claim 13, wherein the coating layer includes an opaque coating to achieve areas of selective illumination.

16. The trim component of claim 13, wherein the coating layer includes a compound, wherein the compound comprises at least one silica, alumina, talc, stearates, low molecular weight thermoplastics, or waxes.

17. The trim component of claim 10, wherein the translucent synthetic resin is made of a material comprising at least one of polycarbonate, acrylic, polystyrene, polypropylene, ABS/MABS, polypropylene, TPU, PSU, polyamide, polyesters, styrenics, ASA, polysilicone, PETG, or PCABS.
